(19) United States
(12) Patent Application Publication
(10) Pub. No.: US 2015/0058213 A1
(43) Pub. Date: Feb. 26, 2015

(54) PREVENTATIVE SECURITY FOR CREDENTIAL TRANSMISSION USING SMART CARDS

(71) Applicant: Rogers Communications Inc., Toronto (CA)

(72) Inventors: Jeffrey David LEE KIM-KOON, North York (CA); Levent YILMAZ, North York (CA)

(21) Appl. No.: 13/972,184

(22) Filed: Aug. 21, 2013

(51) Int. Cl. G06Q 20/32

(52) U.S. Cl. CPC G06Q 20/3229; G06Q 20/3278
USPC 705/41

(57) ABSTRACT

A method, smart card and electronic device which disable transmission of a credential stored on the smart card are described. In one aspect, the method includes: detecting occurrence of a predetermined trigger condition associated with a power state transition affecting the smart card storing the credential; and in response to detecting occurrence of the predetermined trigger condition, adjusting a registry to de-activate an applet associated with the credential, the registry controlling wireless transmission of the credential such that when the applet associated with the credential is de-activated, wireless transmission of that credential is prevented and when the applet associated with the credential is activated, wireless transmission of that credential is permitted.

### TECHNICAL FIELD

The present disclosure relates to smart cards and, more particularly, to methods and systems for securing smart cards which store credentials that may be used for wireless authentication.

### BACKGROUND

Smart cards, such as subscriber identity module (SIM) cards, are sometimes used for wireless authentication. For example, electronic devices are increasingly being used as mobile wallets. More particularly, a SIM card may be inserted within an electronic device and payment credentials stored on the SIM card may be used to perform a financial transaction using the electronic device. For example, the electronic device may be equipped with near field communication (NFC) technology and can be brought near an NFC-equipped point of sale (POS) terminal to submit payment for a transaction using payment credentials stored on the SIM card.

As with any financial transaction, when financial transactions are performed using a smart card (such as an electronic device with a SIM card), there exists many possibilities for fraud. For example, a fraudster may attempt to place a SIM card into an unauthorized electronic device to attempt to process a financial transaction using payment credentials which should not be available to the fraudster.

### BRIEF DESCRIPTION OF THE DRAWINGS

Reference will now be made, by way of example, to the accompanying drawings which show example embodiments of the present application and in which:

FIG. 1 is a block diagram of an example smart card in accordance with example embodiments of the present disclosure;

FIG. 2 is a block diagram of an example electronic device in accordance with example embodiments of the present disclosure;

FIG. 3 illustrates a front view of the electronic device engaging in a payment with a payment terminal in accordance with example embodiments of the present disclosure;

FIG. 4 is a flowchart depicting a method of adjusting a registry in accordance with example embodiments of the present disclosure;

FIG. 5 is a flowchart depicting a further method of adjusting a registry in accordance with example embodiments of the present disclosure;

FIG. 6 is a flowchart depicting a further method of adjusting a registry in accordance with example embodiments of the present disclosure;

FIG. 7 is a flowchart of a further method of adjusting a registry in accordance with example embodiments of the present disclosure; and

FIG. 8 is a flowchart of a further method of adjusting a registry in accordance with example embodiments of the present disclosure.

Like reference numerals are used in the drawings to denote like elements and components.

### DETAILED DESCRIPTION OF EXAMPLE EMBODIMENTS

In one aspect, disclosed is a method for disabling wireless transmission of a credential stored on a smart card. The method includes: detecting occurrence of a predetermined trigger condition associated with a power state transition affecting the smart card storing the credential; and in response to detecting occurrence of the predetermined trigger condition, adjusting a registry to de-activate an applet associated with the credential, the registry controlling wireless transmission of the credential such that when the applet associated with the credential is de-activated, wireless transmission of that credential is prevented and when the applet associated with the credential is activated, wireless transmission of that credential is permitted.

In another aspect, a smart card is described. A smart card includes one or memory storing a registry and a credential deactivation applet. The applet includes instructions for, in response to detecting occurrence of a predetermined trigger condition associated with a power state transition affecting the smart card, adjusting a registry to de-activate an applet associated with the credential, the registry controlling wireless transmission of the credential such that when the applet associated with the credential is de-activated, wireless transmission of that credential is prevented and when the applet associated with the credential is activated, wireless transmission of that credential is permitted.

In another aspect, an electronic device is described. The electronic device includes: a smart card interface for receiving a smart card and the smart card inserted within the smart card interface. The smart card includes one or memory storing a registry and an applet. The applet includes instructions for, in response to detecting occurrence of a predetermined trigger condition associated with a power state transition affecting the smart card, adjusting a registry to de-activate an applet associated with the credential, the registry controlling wireless transmission of the credential such that when the applet associated with the credential is de-activated, wireless transmission of that credential is prevented and when the applet associated with the credential is activated, wireless transmission of that credential is permitted.

Other example embodiments of the present disclosure will be apparent to those of ordinary skill in the art from a review of the following detailed description in conjunction with the drawings.

### Example Smart Card

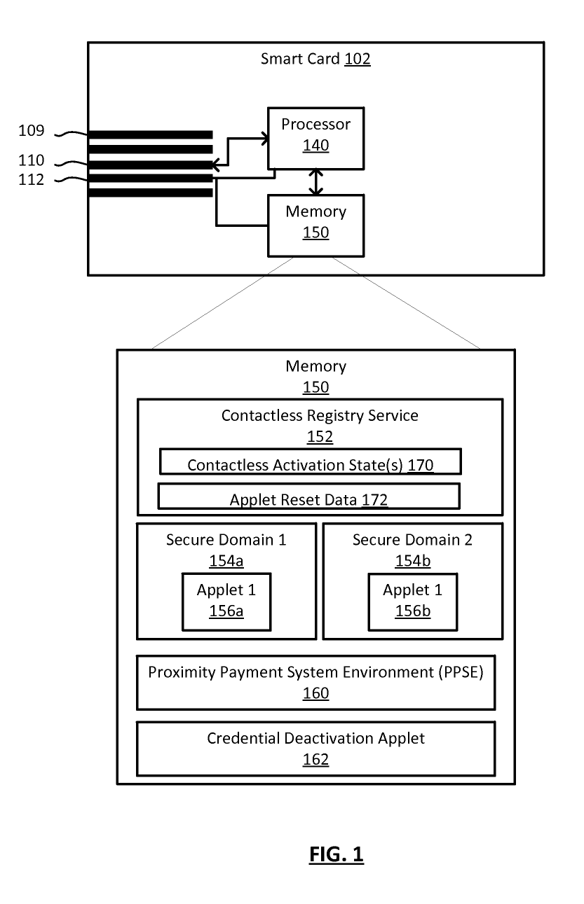

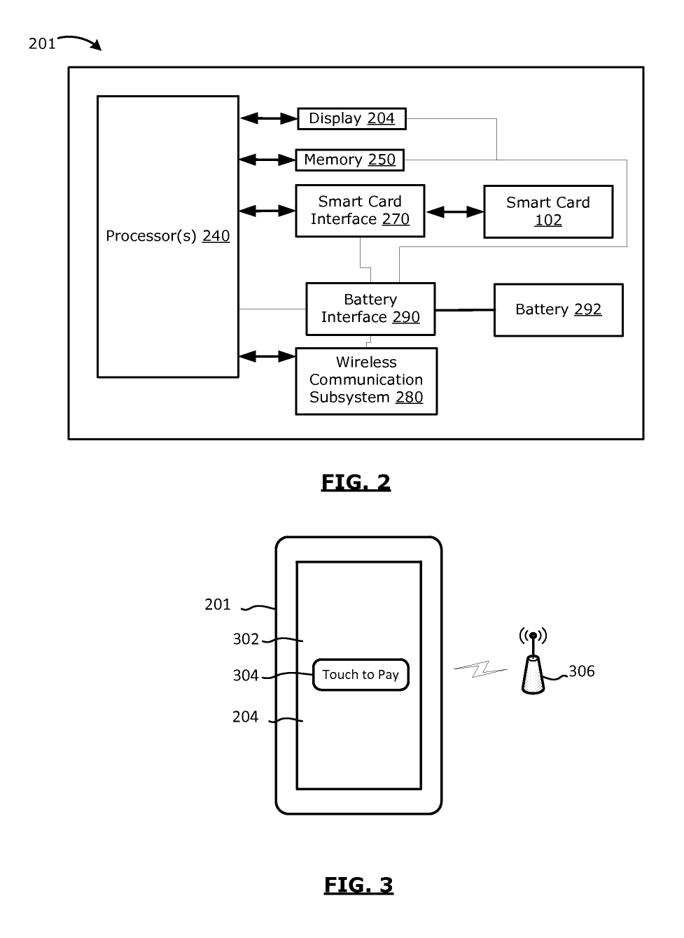

FIG. 1 is a block diagram of an example smart card 102. The smart card may, in various embodiments, be referred to as a chip card or an integrated circuit card (ICC) or a subscriber identity module (SIM) card. The smart card 102 includes embedded integrated circuits and may include, for example, a processor 140. The processor 140 may be configured to execute processor-executable instructions which may, for example, be stored in a memory 150. Thus, the processor 140 may be coupled with the memory. In at least some embodiments, at least some of these processor-executable instructions may be provided in the form of an applet such as a credential deactivation applet 162, which will be discussed in greater detail below. The processor 140 of the smart card 102 (or the processor 240 of an associated electronic device 201 (FIG. 2)) may execute the instructions of the applet.

In at least some embodiments, the processor 140 is a microprocessor. The microprocessor is a programmable device that may be configured to process data according to the processor-executable instructions stored in memory. In at least some embodiments, the processor 140 and at least some memory 150 may be provided as a microcontroller. Thus, the processor 140 may, in various embodiments, be referred to as a microcontroller, a microprocessor, a controller, or a processor.

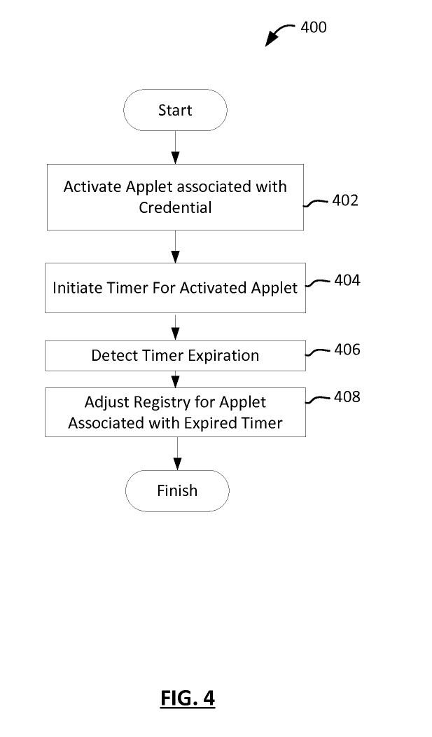

The smart card 102 includes one or more interfaces 109 which may be used to allow the smart card 102 to interact with an external device, such as an electronic device 201 (FIG. 2) or a contactless terminal 306 (FIG. 3). In the embodiment of FIG. 1, the interface 109 is a contact interface, which is a physical connector which may be used on the smart card 102 to physically connect the smart card 102 to an electronic device. More particularly, the interface 109 is comprised of contact pads or pins. These contact pads provide electrical connectivity to the external device. These contact pads may be configured according to a standard such as, for example, the ISO/IEC 7810 and ISO/IEC 7816 series of standards. These standards may define the physical shape and characteristics of the contact pads.

The interface 109 (such as the contact pads) may include one or more communication interfaces 110 which allow the smart card 102 to communicate with an external device. That is, the communication interface 110 permits the smart card 102 to send data to and receive data from the external device. The data received at the smart card 102 may be provided to the processor 140 of the smart card 102 for processing. Similarly, the processor 140 of the smart card 102 may be involved in the sending of data from the smart card 102 to the external device.

The interface 109 may also include a power interface 112 which may be used to provide the smart card 102 with an external source of power. For example, the smart card 102 may receive power from an external device to which the smart card 102 is connected. The power interface 112 may connect to various components of the smart card to provide power to those components. For example, the power interface 112 may provide electrical power to the processor 140 and the memory 150.

In some embodiments, the smart card may include an interface 109 which is contactless. That is, a contactless interface may be provided on the smart card instead of or in addition to the contact interface. The contactless interface allows the smart card to wirelessly send data to an external device and receive data from an external device. For example, the contactless interface may permit the smart card 102 to communicate with a contactless terminal 306 (FIG. 3), such as a payment terminal.

Accordingly, the contactless interface may allow the smart card 102 to communicate with the contactless terminal 306 (which may be referred to as a reader, in some embodiments). The contactless interface may also, in at least some embodiments, power the smart card 102 using radio frequency (RF) induction technologies.

The smart card 102 may, in some embodiments, be a stand-alone contactless payment card such as a credit card and may, in other embodiments, be a contact-based card which requires connectivity with an associated electronic device 201 to facilitate a contactless communication. For example, in some embodiments, the smart card 102 may be a subscriber identity module (SIM) card, which may be abbreviated as a SIM or a SIM card.

A SIM card is an integrated circuit which may be inserted into a smart card interface 270 (also known as a SIM interface) of an electronic device 201 (FIG. 2). An example of one such electronic device 201 will be described in greater detail below with reference to FIG. 2. The SIM card stores information that may be used to allow the electronic device 201 to communicate with a wireless network. More particularly, the SIM may be used to identify and authenticate subscribers on an electronic device that is a mobile telephony device.

The SIM stores, in memory 150, authorization or authentication information which may be used to enable communication services on the electronic device. For example, an international mobile subscriber identity (IMSI) may be securely stored on the SIM. The IMSI may be used by a mobile network operator (MNO) to authenticate an electronic device to which the SIM is inserted.

The SIM may also include an Integrated Circuit Card Identifier (ICCID) which identifies the SIM card. The ICCID may, for example, include an issuer identification number (IIM) and an individual account identification. The issuer identification number (IIN) may be used to identify a home network associated with the SIM. The home network is the network to which the SIM subscribes.

In at least some embodiments, the SIM card may have mobile wallet functionality included. More particularly, the SIM card may have data stored thereon which allows an electronic device 201 (FIG. 2) containing the SIM card to interact with a contactless terminal 306 (FIG. 3). The mobile wallet functionality provided by the SIM card may, for example, allow the electronic device 201 to provide a payment (in which case the contactless terminal 306 may be referred to as a payment terminal or a point of sale (POS) terminal). The SIM card may provide other mobile wallet functionality instead of or in addition to the payment functionality. For example, the SIM card may allow the electronic device 201 to interact with a contactless terminal 306 to perform any one or more of the following functions: provide identification information for a user of the electronic device (i.e. to act as a driver's license, passport, etc.), act as a transit pass (e.g. indicate to the contactless terminal that a user is authorized to use a particular public transit system), unlock a secure door, etc. It will be appreciated that this list of mobile wallet features is not intended to be exhaustive.

The mobile wallet functionality associated with the SIM card (or non-SIM smart card) may be enabled using data and other information stored in memory 150 of the smart card 102. Example contents of the memory 150 will now be discussed.

A standard, such as a GlobalPlatform standard may define certain features of the memory 150. For example, some of the data stored in the memory 150 may be data that is defined according to a GlobalPlatform standard document (or another standard) and at least some of the data may be structured according to a GlobalPlatform standard document (or another standard).

The memory 150, in at least some embodiments, may include one or more secure domains 154a, 154b. A secure domain is an area of memory that is secured. That is, the secure domain may be secured using a secure key to prevent unauthorized applications and applets to access the information stored on the secure domain. In at least some embodiments, each secure domain 154a, 154b may be associated with a different credential. That is, a first secure domain 154a may be associated with a first credential and a second secure domain 154b may be associated with a second credential. Each credential (and each secure domain) may be issued by a separate credential issuing authority. A credential issuing authority is an organization which issues a credential. By way of example, a credential may be a credential that may be used to authorize completion of a financial transaction when the electronic device 201 (or the smart card 102) engages a contactless terminal 306 (FIG. 3). That is, the credential may be a payment credential associated with a mobile wallet. For example, at least some credentials may be issued by a bank or other financial institution, such as a credit card company.

The secure domain acts as a secure partition to wall off information. For example, applications and applets associated with one secure domain may be prevented from accessing information stored in another secure domain.

In at least some embodiments, applets may control the transmission of a credential stored on the smart card 102. For example, the secure domains 154a, 154b may have applets 156a, 156b associated therewith. An applet 156a, 156b associated with a secure domain 154a, 154b may be associated with the credential that is provided within that secure domain 154a, 154b. More particularly, a first applet 156a operating within a first secure domain 154a may provide access to a credential that is associated with the first secure domain 154a. Similarly, a second applet 156b operating within a second secure domain 154b may provide access to a credential that is associated with the second secure domain 154b. The applets 156a, 156b associated with the secure domains may be activated or not-activated. When an applet is activated, the credential associated with that applet may be wirelessly transmitted. However, when an applet is de-activated, the credential associated with the applet may not be wirelessly transmitted. Methods by which an applet associated with a credential may be “activated” or de-activated” will be now be described.

The activation of an applet 156a, 156b associated with a credential may be controlled by a registry provided on the smart card 102 (e.g. in memory 150). More particularly, a registry stored in memory may indicate whether a particular applet 156a, 156b associated with a particular security domain is activated or de-activated. This registry may be referred to as a contactless registry service (CRS) 152 in at least some embodiments.

The contactless registry service 152 (and/or the smart card 102) may have features described in GlobalPlatform Card Contactless Services Card Specification, such as GlobalPlatform Card Contacless Services Card Specification v.2.2 Amendment C v1.1, which is available at www.globalplatform.org, the contents of which are incorporated by reference. Further, the smart card 102 may be of the type described in a GlobalPlatform Card Specification such as GlobalPlatform Card Specification 2.2.1, which is available at www.globalplatform.org, the contents of which are incorporated herein by reference.

The CRS 152 includes a contactless registry, which is an extension of the GlobalPlatform registry. The CRS 152 may include an application programming interface (API) which is configured to allow applets and applications to issue commands related to the registry. The CRS 152 maintains the contactless registry and provides contactless registry information upon request from an authorized entity, such as the credential deactivation applet 162, which will be described in greater detail below.

The CRS 152 maintains contactless activation states 170 associated with a plurality of the applets 156a, 156b. More particularly, a contactless activation state 170 may be defined in the CRS 152 for each of the applets 156a, 156b associated with a credential. That is, states for the applets 156a, 156b associated with the secure domains 154a, 154b may be defined in the CRS 152. The contactless activation states supported by the CRS 152 may include an activated state and a deactivated state.

The contactless activation state (CRS) 170 for an applet controls the wireless transmission of the credential associated with that applet such that when the contactless activation state for an applet is set to deactivated, the associated applet is deactivated and wireless transmission of the credential associated with that applet is prevented and when the contactless activation state for an applet is set to activated, the associated applet is activated and wireless transmission of the credential associated with that applet is permitted. That is, when a contactless activation state for an applet is set to activated, the credential associated with that applet will be wirelessly transmitted.

The memory 150 includes a proximity payment system environment (PPSE) application 160. The PPSE is configured to determine which applets are to be used for wireless transmission. More particularly, the PPSE 160 is used by contactless terminals to determine which applets 156a, 156b are to be used to wirelessly transmit a credential. That is, the PPSE 160 is used to effectively determine which credentials will be wirelessly transmitted e.g. for mobile payment. In order to make this determination, the PPSE 160 consults the registry. More particularly, the PPSE 160 relies upon the contactless activation states 170 for the applets to determine whether a particular applet will be used for a contactless communication with a contactless terminal 306 (FIG. 3). If the contactless activation state of a particular applet is set to activated, then the PPSE may use that applet for a contactless communication. That is, the credential associated with that applet may be wirelessly transmitted to a contactless terminal. If, however, the contactless activation state of a particular applet is set to de-activated, then the PPSE may not use that applet for a contactless communication. That is, the credential associated with the deactivated applet cannot be wireless transmitted to the contactless terminal.

In ordinary operation, an applet 156a, 156b stored in the memory 150 may be activated in response to user input. For example, a user may interact with a graphical user interface on a display of an associated electronic device 201 (FIG. 2) to input an instruction which causes an applet 156a, 156b to become activated (i.e. the contactless activation state 170 of the applet may be updated to “activated”). As will be described in greater detail below with reference to FIG. 4, the activation of the applet may cause a timer to be initiated which keeps track of the length of time that the applet has been activated. In ordinary operation, upon expiration of the timer, the contactless activation state 170 of that applet may be set back to “deactivated”, so that the credential associated with that applet can no longer be used in a contactless communication. Such techniques of activating and deactivating an applet may, in ordinary operation, provide for secure contactless transactions and communications. However, security may be compromised when a power state transition occurs at the smart card 102.

A power state transition may occur when the smart card 102 loses power. This may occur, for example, when the smart card 102 is inserted into an electronic device 201 (FIG. 2) and that electronic device 201 loses power (e.g. when a battery is pulled or loses power) or when the smart card 102 is physically removed from the electronic device 201 so that it is unable to receive power from the electronic device 201. When such power state transitions occur, security on the smart card 102 may be compromised. More particularly, an applet which was previously activated (i.e. prior to the power state transition) may remain activated when the smart card 102 later receives power. For example, if an applet is activated and the smart card 102 containing that applet is removed from an electronic device 201 and inserted into a fraudster's electronic device, then, without additional security measures, the applet may remain activated allowing the fraudster to, for example, perform a contactless payment.

To further secure the smart card from security threats associated with a power state transition, the smart card 102 includes a credential deactivation applet 162. The credential deactivation applet 162 may operate in a higher-level domain than the secure domains 154a, 154b containing the applets 156a, 156b associated with the credentials. For example, the credential deactivation applet 162 may operate within a mobile network operator (MNO) security domain. The credential deactivation applet 162 is comprised of processor-executable instructions which may, in at least some embodiments, be executed during a boot sequence of the smart card 102. That is, when the smart card 102 is first booted following a loss of power to the smart card 102, the credential deactivation applet 162 may automatically be executed.

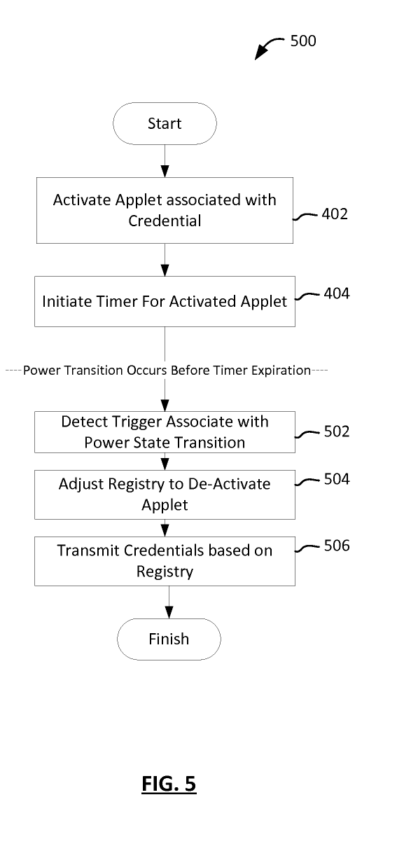

The credential deactivation applet 162 is generally configured to reset the contactless activation state 170 for one or more applets 156a, 156b back to the deactivated state. For example, certain applets which were activated prior to a power state transition (e.g. a loss of power) may be returned to a deactivated state during the boot sequence. Specific functions and features of the credential deactivation applet 162 will be described in greater detail below with reference to FIGS. 5 to 8. Generally, the credential deactivation applet 162 may detect an occurrence of a predetermined trigger condition associated with a power state transition affecting the smart card storing a credential and may, in response to detecting occurrence of the predetermined trigger condition, adjust the registry (e.g. the CRS 152) to de-activate an applet 156a, 156b associated with the credential (e.g. by setting the contactless activation state 170 for that applet to deactivated). As noted above, the registry controls wireless transmission of the credential such that when the applet associated with the credential is de-activated, wireless transmission of that credential is prevented and when the applet associated with the credential is activated, wireless transmission of that credential is permitted.

As noted above, the credential deactivation applet 162 may be executed during a boot sequence of the smart card. The credential deactivation applet 162 may, in at least some embodiments, be a Java applet.

Applets 156a, 156b that are associated with credentials may, in at least some embodiments, be permitted to determine whether the credential deactivation applet 162 will be permitted to adjust their contactless activation state 170. For example, an applet associated with a highly secure use, such as an applet used for contactless payments, may opt to allow the credential deactivation applet 162 to reset its contactless activation state 170 to deactivated, while an applet associated with a less secure use, such as an applet used to authorize use on a transportation system (such as a subway), may opt to not allow the credential deactivation applet 162 to reset its contactless activation state 170 to deactivated. Thus, in at least some embodiments, applet reset data 172 may be defined in the memory 150.

The applet reset data 172 defines the specific applet(s) which the credential deactivation applet 162 is permitted to adjust. More specifically, the applet reset data 172 defines the specific applet(s) which the credential deactivation applet 162 is permitted to deactivate. The applet reset data 172, in at least some embodiments, may take the form of a whitelist which identifies applets which are to be adjusted by the credential deactivation applet 162. In such embodiments, any applets that are not included on the list cannot be adjusted by the credential deactivation applet.

Alternatively, in some embodiments, the applet reset data 172 may take the form of an exception list, which may also be referred to as a blacklist. This type of list identifies applets that are not to be adjusted by the credential deactivation applet 162. In such embodiments, any applets that are not on the list but that have a contactless activation state currently set to activated may be adjusted (i.e. their contactless activation state may be set to deactivated).

In the embodiment illustrated, the applet reset data 172 is provided in the CRS 152. In other embodiments, the applet reset data 172 may be defined in another location. For example, the applet reset data 172 may be defined using a specific flag in the applet 156a, 156b itself. For example, an applet 156a, 156b associated with a credential may have a particular flag which indicates whether the contactless activation state 170 for that applet may be adjusted by the credential deactivation applet 162.

The smart card 102 may take a variety of forms and may be referred to using a variety of terms depending on the embodiment. In some embodiments, the smart card 102 may be a Java card. In other embodiments, the smartcard may be multi-application smart card operating system (MULTOS) card.

While a single memory is illustrated in FIG. 1, the smart card 102 may include multiple memory components and the memory components may take different forms. The memory may, for example, include flash memory, random access memory (RAM), read only memory (ROM), or memory of another type.

### Example Electronic Device

Reference is next made to FIG. 2 which illustrates an example electronic device 201 in block diagram form. In at least some example embodiments, the electronic device 201 is a mobile communication device which is capable of voice and data communications with other devices, systems and servers, for example, via a wireless network.

The electronic device 201 includes a controller which includes one or more processors 240 which control the overall operation of the electronic device 201. The processor 240 may be communicably coupled with device subsystems including memory 250, a smart card interface 270, a display 204, a wireless communication subsystem 280, and other device subsystems.

The memory 250 may include multiple memory components of various types such as flash memory, random access memory (RAM), read only memory (ROM), a hard disk drive (HDD), a solid state drive (SSD), or other types of memory. The memory 250 may, in at least some embodiments, store data and/or processor-executable instructions which may be executed by the processor 240.

The display 204 may be configured to display a graphical user interface which includes a number of different display screens. The display of a particular display screen may depend on an operating mode of the electronic device 201. That is, different display screens are displayed when the electronic device 201 is operating in different operating modes.

The wireless communication subsystem 280 is a contactless communication subsystem which allows the electronic device 201 to communicate with a contactless terminal 306 (FIG. 3). More particularly, the wireless communication subsystem 280 may be a short-range communication subsystem, such as a near field communication (NFC) subsystem.

The electronic device 201 includes a power source which provides electrical power to electrical components of the electronic device 201 including, for example, the processor 240, the display 204, the memory 250, the smart card 272 (i.e. via the smart card interface 270) and the wireless communication subsystem 280. In the example illustrated, the power source is a battery 292 which is removably inserted within the electronic device 201 via a battery interface 290. It will be appreciated that the electronic device 201 may include or be connectable to another power source instead of or in addition to the battery 292. For example, the electronic device 201 may connect to an external power source such as an alternating current (AC) power source using a cable connection.

The smart card interface 270 is configured to receive a smart card 102, which may be of the type described above with reference to FIG. 1. As noted in the discussion of FIG. 1, in at least some embodiments, the smart card 102 may be configured for insertion into the electronic device 201. More particularly, the smart card interface 270 may be configured to engage the interface 109 of the smart card 102. For example, the electronic device's processor 240 may communicate with the smart card 102 via the communication interface 110 of the smart card 102 using the smart card interface 270. Similarly, the power interface 112 of the smart card 102 may receive electric power from the electronic device's power source (e.g. the battery 292) via the smart card interface 270.

As noted in the discussion of FIG. 1 above, the smart card may be a SIM card and the SIM card may enable wireless communications via a wireless network.

The processor 240 may also be communicably coupled with other device subsystems that may not be specifically illustrated such as, for example, one or more input interfaces (such as a keyboard, control buttons, a microphone, a touchscreen display, a mouse, a trackpad, a microphone and/or other input interfaces), one or more output interfaces which may be provided instead of or in addition to the illustrated display 204 (such as a speaker), and one or more communication subsystems for communicating wirelessly with other systems, servers and/or electronic devices via a wireless network. The processor 240 may be communicably coupled with other device subsystems not specifically described herein.

The processor 240 may operate under stored program control and may execute software modules stored on the memory 250. The software modules may be comprised of, for example, operating system software, and one or more additional modules which may configure the electronic device 201 to carry out specific functions. For example, one or more mobile wallet applications may be used to allow the electronic device 201 to interact with a contactless terminal 306 via the wireless communication subsystem 280 using credentials stored on the smart card 102.

The operating system is software that manages the electronic device 201 components (such as the input interface, the output interface, the communication subsystem(s), etc.) and provides a platform for the other software modules, such as the mobile wallet application(s). The operating system may be Microsoft Windows OS™, iOS™, Linux™, UNIX™, Android™ or any other operating system having the necessary capabilities for implementing the functions described herein.

While the electronic device 201 of FIG. 2 includes a removable smart card, in other embodiments, the electronic device 201 may include an embedded smart card, such as an embedded SIM. In at least some embodiments, the embedded SIM may be soldered directly onto a circuit board of the electronic device 201. It will be appreciated that an embedded smart card may have interfaces that differ from those discussed above with reference to FIG. 1.

Furthermore, while the electronic device 201 of FIG. 2 illustrates a single smart card 102, in other embodiments, the electronic device 201 may be configured to operate with multiple smart cards 102. For example, in at least some embodiments, the electronic device 201 may be configured to operate with dual SIM cards. That is, the electronic device 201 may be a dual SIM electronic device, which is an electronic device which holds two SIM cards. Dual SIM operation allows the use of multiple services without having to carry multiple phones. For example, the same electronic device 201 may be used for both business and personal use. In such embodiments, one or both of the SIM cards may be configured with the mobile wallet features described above with reference to FIG. 1 and with any of the applet deactivation features described herein.

### Example Communication Scenario

Referring now to FIG. 3, an example communication scenario will now be described.

In the example scenario, the electronic device 201 of FIG. 2, which is equipped with the smart card 102 of FIG. 1 is brought within communication range of a contactless terminal 306 in order to communicate with the contactless terminal 306 using a credential associated with one of the applets 156a, 156b (FIG. 1) of the smart card 102.

The credential may, for example, be a payment credential and the contactless terminal 306 may be a payment terminal 306 (which may also be referred to as a point-of-sale terminal. The payment terminal may be a terminal that may be used to process a financial transaction and may be used, for example, in a retail context. For example, the payment terminal 306 may be a credit card and/or bank card terminal which allows a financial transaction to be processed using a credential which represents credit card and/or banking information.

In some embodiments, the communication between the electronic device 201 and the contactless terminal 306 may be initiated when the electronic device 201 is brought within a certain range of the contactless terminal 306. The range may, for example, be a few inches and may be determined based on the coverage area of the wireless communication subsystem 280 and/or the contactless terminal 306.

In some embodiments, in order to initiate the communication between the electronic device 201 and the contactless terminal 306, further action may be required of a user. For example a display screen 302 may be displayed on the display 204 of the electronic device 201 which includes an interface element 304 which allows a user to input an instruction to use a credential stored on the smart card 102. For example, in the illustrated embodiment, the interface element 304 is a virtual button with the label “Touch to Pay” which is displayed on a touchscreen display. The interface element 304 may be displayed in response to a predetermined triggering condition such as, for example, when the electronic device 201 is brought within the vicinity of the contactless terminal 306 and/or when a particular application (such as a mobile wallet application) is initiated on the electronic device. The interface element 304 may be associated with a particular credential (i.e. it may be associated with a specific one of the applets 156a, 156b stored in the secure domains 154a, 154b). For example, the interface element 304 may be associated with a specific credit card.

The display screen 302 may, for example, be displayed by the electronic device's mobile wallet application. That is, the mobile wallet application may include instructions which cause the display screen 302 to be generated and displayed.

Activating the interface element 304 and/or bringing the electronic device 201 within the vicinity of the contactless terminal 306 may cause the electronic device 201 to initiate a communication with the contactless terminal 306. More particularly, in response to activating the interface element 304 and/or bringing the electronic device 201 within the vicinity of the contactless terminal 306, an applet 156a, 156b associated with a credential may be activated on the electronic device 201. Where the interface element 304 is associated with a particular credential, the specific applet 156a, 156 associated with that credential may be activated. For example, if the interface element 304 is associated with a particular credit card, then the applet 156a, 156b associated with that credit card may be activated.

In at least some embodiments, the applet 156a, 156b is activated by updating a registry (i.e. the contactless registry service 152) on the smart card 102. More particularly, the contactless activation state 170 of the applet 156a, 156b may be set to an activated state. As noted in the discussion of FIG. 1 above, the PPSE 160 is configured to rely on the contactless activation state 170 of an applet 156a, 156b for contactless communications. When an applet's contactless activation state is set to activated, the credential associated with that application may be transmitted to the contactless terminal 306 using the wireless communication subsystem 280 (FIG. 2)

For security purposes, one or more of the applets may not remain “activated” indefinitely. That is, the wireless communication subsystem 280 may not continually transit a credential associated with an applet 156a, 156b. Instead, the applet may be deactivated after one or more conditions are satisfied.

Referring now to FIG. 4, an example of one condition which may cause an applet to become deactivated will now be described.

FIG. 4 illustrates an example method 400 for deactivating an applet associated with a credential. The method 400 may, for example, be performed by one or more processor. For example, a processor 240 on the electronic device 201 (FIG. 2) may perform the method 400 and/or a processor 140 on the smart card 102 (FIG. 1) may perform the method 400. In some such embodiments, a memory (such as the memory 150 of the smart card 102 and/or the memory 250 of the electronic device 201) may include processor-executable instructions which, when executed, cause the processor to perform the method 400.

At 402, an applet associated with a credential is activated. That is, the contactless registry service 152 is updated so that the contactless activation state 170 of an applet is set to activated. This may occur when one or more of the triggers discussed above with reference to FIG. 3 occur. For example, this may occur when the interface element 304 is activated and/or the electronic device 201 is brought within the vicinity of the contactless terminal 306. The activation of the applet causes a credential associated with the applet 156a, 156b to be used for contactless communications. For example, the credential may be transmitted to a contactless terminal 306 (FIG. 3) via a wireless communication subsystem 280 (FIG. 2) of the electronic device 201, such as an NFC subsystem.

The activation of the applet may also cause a timer to be initiated at 404. In at least some embodiments, the timer may be maintained on the smart card 102. The timer is used to keep track of the length of time which the applet 156a, 156b has been activated. In ordinary operation, at 406 the expiration of the timer may be detected. The timer expires when the elapsed time indicated by the timer is at least a predetermined period of time. The predetermined period of time may, for example, be in the range of twenty to forty seconds.

Upon detecting expiration of the timer, at 408, the applet that was enabled at 402 may be automatically deactivated. More particularly, the registry may be updated to deactivate the applet. In at least some embodiments, the deactivation of the applet may be performed by updating the contactless activation state 170 for that applet in the CRS 152 to a deactivated state. As noted in the discussion of FIG. 1 above, the contactless activation state 170 of the CRS 152 may control whether a credential associated with an applet will be used in a contactless communication. When the contactless activation state 170 for an applet is set to activated, the credential associated with that applet may be used (e.g. by the PPSE 160) in a contactless communication; when the contactless activation state 170 is set to deactivated, the credential is not used in the contactless communication. Thus, by setting the contactless activation state 170 for an applet to deactivated, the credential associated with that applet is not used.

While the technique of FIG. 4 may, in most operating environments, allow for the safe and secure use of credentials for contactless communications, in some scenarios, security may be compromised without additional preventative measures. For example, in some scenarios, a power state transition may occur at the smart card 102 and/or the electronic device 201 before the timer expires which may affect the security of the credential.

A power state transition may occur, for example, if the power source providing electrical power to the smart card 102 and/or the electronic device 201 is removed or depleted. For example, the battery 292 of the electronic device 201 may be removed from the battery interface 290 or may become depleted after usage of the electronic device 201. In another scenario, a power state transition may occur when the smart card 102 is removed from the electronic device 201.

When such power state transitions occur, the smart card 102 may lose power before the registry is adjusted (e.g. at 408 of FIG. 4) to deactivate the applet. As a result, an applet may remain active later when the smart card 102 once again receives power. This may cause the integrity of the smart card 102 to be compromised. For example, if the timer of the method 400 of FIG. 4 was not implemented, at least in part, using non-volatile components such as non-volatile memory, then the timer may not resume when the smart card 102 later received the electric power. Thus, the applet may remain activated indefinitely in such scenarios, unless the techniques described herein are utilized. In another scenario, the timer may resume where it left off once power is received, but a credential may be used by a fraudster before the timer expires. For example, in one scenario the timer could be set to expire after 30 seconds and the smart card 102 could be removed when only 10 seconds have elapsed and could be inserted into a fraudster's electronic device 201. In such a scenario, without additional security, the applet remains activated for another 20 seconds after being inserted into the fraudster's electronic device 201, allowing the fraudster to, for example, complete a transaction with the credential.

In order to prevent such security vulnerabilities from being exploited, the smart card 102 and/or the electronic device 102 may be configured to reset an applet to a deactivated state in response to a power state transition. Methods of resetting an applet to a deactivated state in response to a power state transition will now be described.

Reset Applet after Power State Transition

FIGS. 5 to 8 are flowcharts of methods 500, 600, 700, 800 for deactivating an applet in response to a power state transition. Any one or more of these methods 500, 600, 700, 800 may, for example, be performed by one or more processor. For example, a processor 240 on the electronic device 201 (FIG. 2) may perform any one or more of the methods 500, 600, 700, 800 and/or a processor 140 on the smart card 102 (FIG. 1) may perform any one or more of the methods 500, 600, 700, 800. In some such embodiments, a memory (such as the memory 150 of the smart card 102 and/or the memory 250 of the electronic device 201) may include processor-executable instructions which, when executed, cause the processor to perform any one or more of the methods 500, 600, 700, 800. For example, in at least some embodiments, the credential deactivation applet 162 may contain processor-executable instructions which cause the processor 140 of the smart card 102 or the processor 240 of an associated electronic device 201 to perform one or more of the methods 500, 600, 700, 800.

Referring first to FIG. 5, a method 500 of resetting an applet in response to a power state transition is illustrated. At 402, an applet associated with a credential is activated in the manner described above with reference to the method 400 of FIG. 4. As noted in the discussion of FIG. 4, in at least some embodiments, at 402 the CRS 152 may be updated. More particularly, a contactless activation state 170 for the applet 156a, 156b may be set to an activated state.

In at least some embodiments, at 404, a timer may be initiated at 404 in response to the activation of the applet in the manner described above with reference to the method 400 of FIG. 4.

In the method 500 of FIG. 5, a power state transition occurs before the expiration of the timer. As noted above, this may happen, for example, when the smart card 102 loses power. Such power loss may occur when a power source associated with an electronic device 201 housing the smart card 102 is disconnected (e.g. if the battery is removed) or depleted or when the smart card 102 is removed from the electronic device 201.

At 502, a predetermined trigger condition associated with a power state transition affecting the smart card 102 is detected. More particularly, the predetermined trigger condition may indicate a loss of power at the smart card 102 and/or the electronic device 201. In some embodiments, the predetermined trigger condition may indicate an increase in available power at the smart card 102 and/or the electronic device 201. For example, the predetermined trigger condition may occur when the smart card 102 is powered up after having previously been powered down.

As noted in the discussion of FIG. 2 above, in some embodiments, the smart card 102 may be configured for insertion into the electronic device 201 (i.e. the smart card 102 may be inserted within a smart card interface 270 (FIG. 2) associated with the electronic device 201). In some such embodiments, the predetermined trigger condition may occur when the smart card 102 is inserted into the electronic device 201. More particularly, it may occur when the smart card 102 is inserted within the smart card interface 270 (FIG. 2). When this happens, the smart card 102 receives power from the electronic device 201 and a power state transition occurs (i.e. it is transitioning from a state where no power is available to a state where power is available).

Similarly, in some embodiments, the predetermined trigger condition may occur when the electronic device 201 and/or the smart card 102 experiences a loss of power. The loss of power may occur, for example, when a battery 292 associated with the electronic device 201 is removed from a battery interface 290 of the electronic device 201 or when the battery is depleted. In some embodiments, the predetermined trigger condition may occur when available power drops below a predetermined threshold which indicates that the power provided by a battery 292 is close to being depleted.

In some embodiments, the predetermined trigger condition occurs when the electronic device 201 is powered on after a loss of power. For example, after a power loss, the electronic device 201 may be powered on when the battery is recharged and/or re-inserted into the battery interface 290. At this time, the processor performing the method 500 may determine that the predetermined trigger condition has occurred.

In some embodiments, the detection of the trigger condition (at 502) may occur when a boot sequence associated with the smart card 102 is initiated or performed. The boot sequence may, for example, be performed when a power state transition occurs. That is, when the smart card 102 receives power after having previously had no supply of power, then the boot sequence may be performed. For example, when the smart card 102 is connected to an external source of power (e.g. when it receives power from an electronic device 201 to which it is inserted) after a period in which it was not connected to the external source of power (e.g. after a period during which it was either not connected to the electronic device 201 or when it was connected but received no power from the electronic device 201 since the power supply of the electronic device 201 was depleted or removed), then the boot sequence may be performed. Since the boot sequence is performed when a power state transition has occurred then the fact that the boot sequence is being performed indicates that a power state transition has occurred. Thus, the predetermined trigger condition which is detected at 502 may be the performance of the boot sequence.

In response to detecting the occurrence of the predetermined trigger condition, at 504, a processor 140, 240 may adjust a registry to de-activate an applet associated with a credential (i.e. the applet activated at 402 may be disabled). As noted in the discussion of FIG. 1, the registry controls wireless transmission of the credential such that when the applet associated with the credential is de-activated, wireless transmission of that credential is prevented and when the applet associated with the credential is activated, wireless transmission of that credential is permitted. The registry may, for example, be the CRS 152 described above with reference to FIG. 1. In at least some such embodiments, at 504, the applet may be deactivated by updating the contactless activation state 170 for the applet to indicate that the applet is deactivated. More particularly, in at least some embodiments, the contactless activation state for the applet (which may be the applet activated at 402) may be changed from an activated state to a deactivated state.

In at least some embodiments, when the contactless activation state 170 for an applet has a first bit (which is a rightmost bit in some embodiments) that is set to one, then the applet may be considered to be activated. In contrast, when the contactless activation state 170 for the applet has a first bit that is set to zero, then that applet may be considered to be deactivated. Thus, in at least some such embodiments, at 504, the first bit of the contactless activation state 170 for the applet is set to zero.

In at least some embodiments, a SET STATUS command may be used to adjust the contactless activation state 170 for an applet. Accordingly, in at least some such embodiments, at 504 a SET STATUS command may be used which causes the contactless activation state 170 for an applet to be set to deactivated.

As noted in the discussion of FIG. 1 above, the registry (i.e. the CRS 152) controls which credentials will be transmitted. For example, the PPSE 160 may be configured to rely on the registry to selectively allow for the use of credentials. That is, the registry may be consulted (e.g. by the PPSE 160) to identify any applets having a contactless activation state 170 set to activated and the credentials associated with those applets may be used. Accordingly, in at least some embodiments, after adjusting the registry at 504, a processor (which may execute instructions of the PPSE) may consult the registry to identify one or more applets having a contactless activation state set to activated. Then, credentials associated with the identified applets may be selectively used/transmitted at 506. It will be appreciated that the applet which was deactivated at 504 will be excluded from use at 506. Thus, by adjusting the registry at 504, use of the applet which was deactivated has been precluded.

### Utilize Residual Power to Assist in Deactivation of Applet

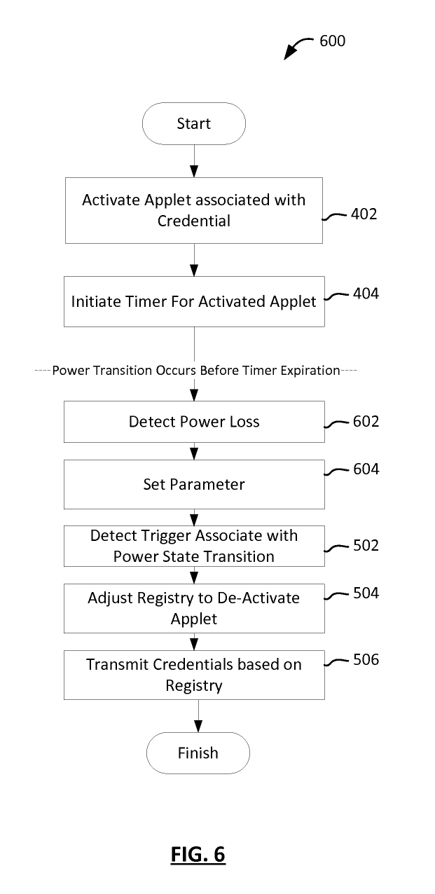

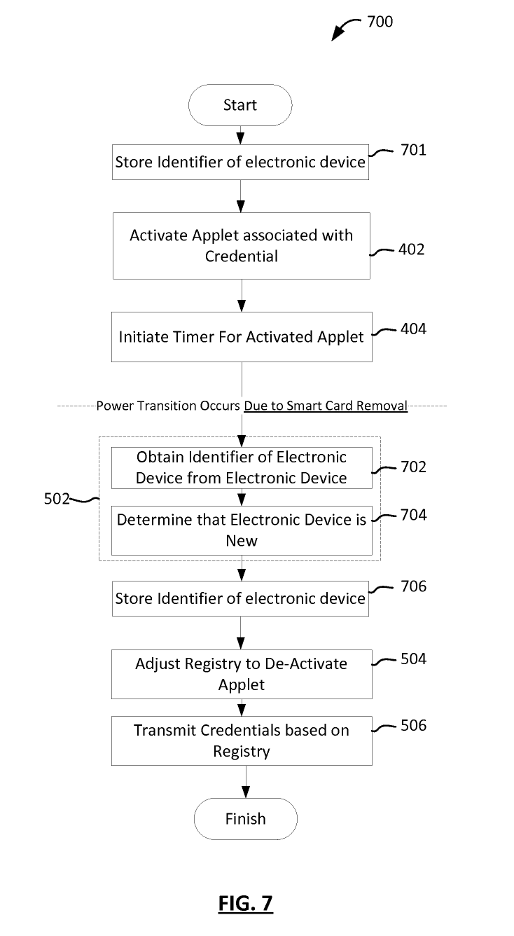

As noted above, in some embodiments, the adjusting of the registry to deactivate an applet may occur during a boot sequence of the smart card 102. In some embodiments, at least a portion of the procedure may be performed during a power-down procedure of the smart card 102. Referring now to FIG. 6, an example method 600 of deactivating an applet is illustrated in flowchart form. As will be described in greater detail below, at least a portion of the method may be performed during a power down procedure of the smart card 102.

The method 600 includes a number of features in common with the method 400 of FIG. 4 and/or the method 500 of FIG. 5. Common reference numerals are used to denote common features and the discussion of these features will not be repeated at length.

At 402, an applet associated with a credential is activated in the manner described above with reference to FIG. 4. Then, at 404, a timer may be initiated for the activated applet in the manner described above with reference to FIG. 4.

A power state transition may then occur due to a loss of power, for example. At 602, a loss of power at the smart card 102 may be detected. This loss of power may be detected, for example, when the power provided to the smart card 102 from an associated electronic device 201 falls below a predetermined threshold. When this happens, a power down sequence may be performed. In some embodiments, during the power down sequence the registry may be adjusted to deactivate the applet which was activated at 402.

In other embodiments, there may not be sufficient power available during the power down sequence to complete the deactivation of the applet. Accordingly, in at least some embodiments, during the power down sequence, at 604, a parameter may be set using residual power to indicate the loss of power. More particularly, in response to detecting the loss of power (at 602), a specific parameter may be set. This may, for example, be performed by setting a specific bit in memory which is set to indicate that a power loss has occurred. The parameter may act as a trigger which is associated with a power state transition.

After the smart card 102 once again receives full power (i.e. after power is restored), then a trigger associated with a power state transition may be detected at 502. More particularly, at 502 the smart card 102 may refer to the parameter that was set at 604. If the parameter is set, then the smart card 102 may determine that a power state transition has occurred. If the parameter is not set, then the smart card 102 may determine that a power state transition has not occurred. Thus, in at least some embodiments, detecting occurrence of the predetermined trigger condition associated with a power state transition includes detecting that the parameter indicates the loss of power.

In response to detecting occurrence of the predetermined trigger condition, the registry is adjusted at 504 to de-activate the applet associated with the credential in the manner described above with reference to FIG. 5 and, if any applets remain activated, then the credentials associated with those activated applications may be selectively transmitted at 506 in the manner described above with reference to FIG. 5.

As noted above, in at least some embodiments, the credential that is associated with the applet that is deactivated at 504 may be a payment credential associated with a mobile wallet. In such embodiments, by deactivating the applet, payment using that credential is prohibited.

In order to preserve at least some residual energy to allow a smart card 102 to perform a power down procedure, in at least some embodiments, the smart card 102 may include or be connected to a capacitor which stores energy that may be used by the smart card 102 when a main power supply is disconnected, partially depleted, exhausted, or otherwise compromised. In at least some such embodiments, the detection of a power loss at 602 may occur when the main power supply is disconnected or otherwise unavailable and the setting of the parameter at 604 may be performed utilizing the residual power available from the capacitor.

Deactivation of Applet when New Electronic Device Identified

In some embodiments, the smart card 102 may be configured to recognize a device switch and/or a new device and to deactivate one or more applets in response to a device switch and/or a new device. More particularly, when a smart card 102 is removed from a smart card interface associated with one electronic device and placed in a smart card interface associated with another electronic device, one or more applets may be deactivated. Similarly, in at least some embodiments, when a smart card 102 is inserted into a new electronic device (i.e. a device which the smart card 102 was previously not inserted within), then one or more applets may be deactivated.

Referring now to FIG. 7, one such method is illustrated. The method 700 includes a number of features in common with the method 400 of FIG. 4 and/or the method 500 of FIG. 5. Common reference numerals are used to denote common features and the discussion of these features will not be repeated at length.

At 701, the smart card 102 may store an identifier of the electronic device 201 which is connected to the smart card 102. That is, the smart card 102 may store in memory 150 the identifier of the electronic device 201 to which the smart card 102 is inserted. The identifier may, for example, be an International Mobile Station Equipment Identity (IMEI), which may be retrieved by the smart card 102 from the electronic device 201 over the communication interface 110. The identifier may, for example, be stored in memory 150 of the smart card 102 during the boot up sequence of the smart card 102.

At 402, an applet associated with a credential is activated in the manner described above with reference to FIG. 4. Then, at 404, a timer may be initiated for the activated applet in the manner described above with reference to FIG. 4.

A power state transition may then occur as the smart card 102 is inserted within a new electronic device 201. This may occur, for example, when the smart card 102 is moved from one electronic device 201 to another electronic device. When the smart card 102 is not inserted into an electronic device, it loses its power supply and when it is inserted into another electronic device it receives power from that electronic device's power supply. Thus, the smart card experiences a power transition. This power transition is detected at 502. More particularly, a trigger associated with a power state transition is detected. In this case, the trigger is an identifier of a new electronic device.

Accordingly, in order to detect the trigger, the smart card 102 obtains (at 702), from the electronic device 201 to which it is inserted, the identifier of the electronic device 201 (e.g. the IMEI). The smart card 102 may then determine whether the electronic device is a new electronic device 201 by comparing the identifier obtained at 702 to the identifier stored at 701. Since, in the example scenario of FIG. 7, a power transition has occurred due to removal of the smart card 102 from the electronic device 201, then the smart card 102 determines that the electronic device is new at 704. That is, the smart card 102 determines that it has been inserted into a new electronic device 201. Since an insertion into a new device indicates that a power state transition has occurred, the smart card 102 effectively determines that a power state transition has occurred since the electronic device 201 to which the smart card 102 is inserted is a different electronic device 201 than the electronic device 201 to which it was previously inserted.

As noted in the discussion of FIG. 5 above, the detection of the trigger associated with a power state transition at 502 may occur during a boot sequence of the smart card 102.

In at least some embodiments, the identifier of the new electronic device 201 may be stored in memory 150 of the smart card 102 at 706. Furthermore, in response to detecting occurrence of the predetermined trigger condition, the registry is adjusted at 504 to de-activate the applet associated with the credential in the manner described above with reference to FIG. 5 and, if any applets remain activated, then the credentials associated with those activated applications may be selectively transmitted at 506 in the manner described above with reference to FIG. 5.

### Selectively Deactivating Applets

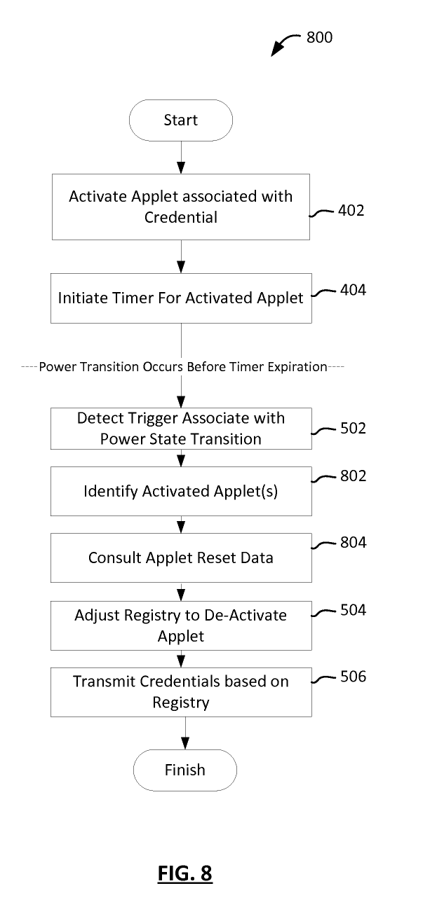

As noted in the discussion above, in at least some embodiments of the present application, an applet that may be used for a contactless communication may be disabled when a power state transition is detected. This may secure certain highly-secure credentials from being used by a fraudster. However, in some cases, the risk of a fraudster using less-secure credentials may be much less than for high-secure credentials. Thus, applets associated with less-secure credentials may be left activated after a power state transition. That is, the smart card 102 may selectively deactivate applets when a power state transition occurs. An example of one such method 800 will now be discussed with reference to the flowchart of FIG. 8.

The method 800 includes a number of features in common with the method 400 of FIG. 4 and/or the method 500 of FIG. 5. Common reference numerals are used to denote common features and the discussion of these features will not be repeated at length.

At 402, an applet associated with a credential is activated in the manner described above with reference to FIG. 4. Then, at 404, a timer may be initiated for the activated applet in the manner described above with reference to FIG. 4.

A power state transition may then occur due to a loss of power, for example. At 602, a loss of power at the smart card 102 may be detected. This loss of power may be detected, for example, when the power provided to the smart card 102 from an associated electronic device 201 falls below a predetermined threshold.

At 502, a trigger condition associated with a power state transition is detected. The trigger condition may be detected according to any one of the techniques described with reference to feature 502 of the methods 500, 600, 700 of FIGS. 5, 6 and 7.

In response to detecting the trigger condition associated with the power state transition, the smart card 102 may identify activated applets at 802 by consulting the contactless registry service. More particularly, the contactless activation states 170 in the CRS 152 may be evaluated to determine which of the applets 156a, 156b are currently activated. The contactless activation states 170 may be retrieved using a GET STATUS command. That is, the GET STATUS command may be used to retrieve the contactless activation state for the applets.

In some embodiments, applet reset data 172 may be consulted at 804 to select one or more applets for adjustment. As noted above, the applet reset data 172 defines the specific applet(s) which the credential deactivation applet 162 is permitted to adjust. More specifically, the applet reset data 172 defines the specific applet(s) which the credential deactivation applet 162 is permitted to deactivate. The applet reset data 172, in at least some embodiments, may take the form of a whitelist which identifies applets which are to be adjusted by the credential deactivation applet 162. In such embodiments, any applets that are not included on the list cannot be adjusted by the credential deactivation applet.

Alternatively, in some embodiments, the applet reset data 172 may take the form of an exception list, which may also be referred to as a blacklist. This type of list identifies applets that are not to be adjusted by the credential deactivation applet 162. In such embodiments, any applets that are not on the list but that have a contactless activation state currently set to activated may be selected for adjustment.

At 504, the smart card 102 may adjust the registry to de-activate an applet in the manner described above with reference to the methods 500, 600, 700 of FIGS. 5 to 7.

In at least some embodiments, the applet(s) that are deactivated at 504 are applets that were identified as being activated during the identifying feature of 802. Furthermore, the deactivation of applets may be performed based on the selection of the one or more applets for adjustment which was performed at 804. That is, the adjustment of the registry may take into account the applet reset data 172.

It is to be understood based on the preceding description that a single applet associated with a single credential may be deactivated at 504 (e.g. a single credit card related applet may be deactivated) in some embodiments and that, in other embodiments, a plurality of applets associated with a plurality of credentials may be deactivated.

The various embodiments presented above are merely examples and are in no way meant to limit the scope of this disclosure. Variations of the innovations described herein will be apparent to persons of ordinary skill in the art, such variations being within the intended scope of the present application. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A method for disabling wireless transmission of a credential stored on a smart card, the method comprising:
detecting occurrence of a predetermined trigger condition associated with a power state transition affecting the smart card storing the credential; and
in response to detecting occurrence of the predetermined trigger condition, adjusting a registry to de-activate an applet associated with the credential, the registry controlling wireless transmission of the credential such that when the applet associated with the credential is de-activated, wireless transmission of that credential is prevented and when the applet associated with the credential is activated, wireless transmission of that credential is permitted.

2. The method of claim 1, wherein the smart card is configured for insertion into an electronic device and wherein the predetermined trigger condition occurs when the electronic device is powered on after a loss of power.

3. The method of claim 1, wherein the smart card is configured for insertion into an electronic device and wherein the predetermined trigger condition occurs when the smart card is inserted into the electronic device.

4. The method of claim 1, wherein the smart card is configured for insertion into an electronic device and wherein the predetermined trigger condition occurs when the smart card experiences a loss of power.

5. The method of claim 1, further comprising:
detecting a loss of power; and
in response to detecting a loss of power, setting a parameter using residual power to indicate the loss of power,
and wherein the detecting is performed after power is restored and wherein the detecting occurrence of the predetermined trigger condition associated with a power state transition comprises detecting that the parameter indicates the loss of power.

6. The method of claim 1, wherein the smart card is configured for insertion into an electronic device wherein detecting occurrence of a predetermined trigger condition comprises:
obtaining, from the electronic device, an identifier of the electronic device; and
determining, based on the identifier of the electronic device, that the smart card has been inserted into a new electronic device.

7. The method of claim 1, wherein the credential is a payment credential associated with a mobile wallet.

8. The method of claim 1, wherein the smart card is a subscriber identity module (SIM) card.

9. The method of claim 1, wherein the registry is a contactless registry service which maintains a contactless activation state associated with a plurality of applets, the contactless activation state for an applet controlling the wireless transmission of the credential associated with that applet such that when the contactless activation state for an applet is set to de-activated, the associated applet is de-activated and wireless transmission of the credential associated with that applet is prevented and when the contactless activation state for an applet is set to activated, the associated applet is activated and wireless transmission of the credential associated with that applet is permitted.

10. The method of claim 9, wherein adjusting a registry comprises changing the contactless activation state for the applet from an activated state to a deactivated state.

11. The method of claim 10, further comprising:
after adjusting the registry, consulting the registry to identify one or more applets having a contactless activation state set to activated; and
selectively transmitting one or more credentials associated with the one or more identified one or more applets.

12. The method of claim 10, wherein changing the contactless activation state comprises setting the first bit of the contactless activation state for the applet to zero.

13. The method of claim 10, wherein changing the contactless activation state comprises issuing a set status command.

14. The method of claim 1, further comprising, prior to adjusting the registry, identifying activated applets by consulting the contactless registry service, and wherein the applet that is de-activated during the adjusting is an applet that was identified as being activated during the identifying.

15. The method of claim 14, wherein identifying activated applets comprises using a get status command to identify activated applets by retrieving the contactless activation state for the applets.

16. The method of claim 1, wherein adjusting the registry comprises adjusting the registry to de-activate a plurality of applets associated with a plurality of credentials.

17. The method of claim 16, further comprising, prior to adjusting the registry, consulting applet reset data to select one or more applets for adjustment, the applet reset data comprising a whitelist identifying applets which are to be adjusted or a blacklist identifying applets that are not to be adjusted, and wherein adjusting the registry comprises de-activating applets based on the selection of the one or more applets for adjustment.

18. A smart card comprising:
one or memory storing a registry and a credential deactivation applet, the applet comprising instructions for, in response to detecting occurrence of a predetermined trigger condition associated with a power state transition affecting the smart card, adjusting a registry to de-activate an applet associated with the credential, the registry controlling wireless transmission of the credential such that when the applet associated with the credential is de-activated, wireless transmission of that credential is prevented and when the applet associated with the credential is activated, wireless transmission of that credential is permitted.

19. The smart card of claim 18 wherein the credential deactivation applet is a Java applet executed during a boot sequence of the smart card.

20. The smart card of claim 18, wherein the smart card is a subscriber identity module card.

21. The smart card of claim 18 further comprising a processor coupled with the one or more memory, and wherein the processor executes the instructions of the credential deactivation applet.

22. An electronic device comprising:
a smart card interface for receiving a smart card; and
the smart card inserted within the smart card interface, the smart card comprising one or memory storing a registry and an applet, the applet comprising instructions for, in response to detecting occurrence of a predetermined trigger condition associated with a power state transition affecting the smart card, adjusting a registry to de-activate an applet associated with the credential, the registry controlling wireless transmission of the credential such that when the applet associated with the credential is de-activated, wireless transmission of that credential is prevented and when the applet associated with the credential is activated, wireless transmission of that credential is permitted.
